(19) United States
(12) Patent Application Publication
(10) Pub. No.: US 2022/0068101 A1
(43) Pub. Date: Mar. 3, 2022

(54) Smoke Detector Monitor Apparatus

(71) Applicant: Kimberly Cloud, Mountain Top, PA (US)

(72) Inventor: Kimberly Cloud, Mountain Top, PA (US)

(21) Appl. No.: 17/009,100

(22) Filed: Sep. 1, 2020

(51) Int. Cl. G08B 17/113; G08B 17/117; G08B 5/36

(52) U.S. Cl. CPC G08B 17/113; G08B 5/36; G08B 17/117

(57) ABSTRACT

A smoke detector monitor apparatus for detecting smoke and monitoring when detection occurs includes a housing having a housing top side, a housing bottom side, a housing front side, a housing back side, a housing left side, and a housing right side. The housing has a plurality of vent apertures extending therethrough. A smoke sensor is coupled within the housing adjacent the plurality of vent apertures. The smoke sensor activates upon detection of smoke from cigarettes, cigars, and cannabis. A CPU is coupled within the housing and is in operational communication with the smoke sensor. A power source is coupled within the housing and is in operational communication with the CPU. A power switch, a time indicator, and a plurality of status lights are coupled to the housing and are in operational communication with the CPU.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to smoke detector devices and more particularly pertains to a new smoke detector device for detecting smoke and monitoring when detection occurs.

### (2) Description of Related Art Including Information Disclosed Under 37 CFR 1.97 and 1.98

The prior art relates to smoke detector devices. Existing devices detect smoke of various forms but activate an alarm on detection rather than having a strictly visual indicator. Existing devices also do not log the date and time of the detection.

### BRIEF SUMMARY OF THE INVENTION

An embodiment of the disclosure meets the needs presented above by generally comprising a housing having a housing top side, a housing bottom side, a housing front side, a housing back side, a housing left side, and a housing right side. The housing has a plurality of vent apertures extending therethrough. A smoke sensor is coupled within the housing adjacent the plurality of vent apertures. The smoke sensor is configured to activate upon detection of smoke from cigarettes, cigars, and cannabis. A CPU is coupled within the housing and is in operational communication with the smoke sensor. A power source is coupled within the housing and is in operational communication with the CPU. A power switch, a time indicator, and a plurality of status lights are coupled to the housing and are in operational communication with the CPU.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a smoke detector monitor apparatus according to an embodiment of the disclosure.

FIG. 2 is a top plan view of an embodiment of the disclosure.

FIG. 3 is a front elevation view of an embodiment of the disclosure.

FIG. 4 is a side elevation view of an embodiment of the disclosure.

FIG. 5 is a block diagram view of an embodiment of the disclosure.

FIG. 6 is an in-use view of an embodiment of the disclosure.

### DETAILED DESCRIPTION OF THE INVENTION

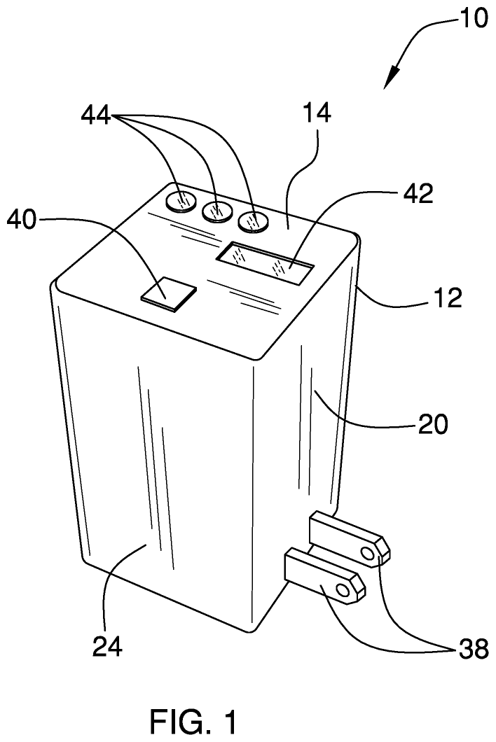

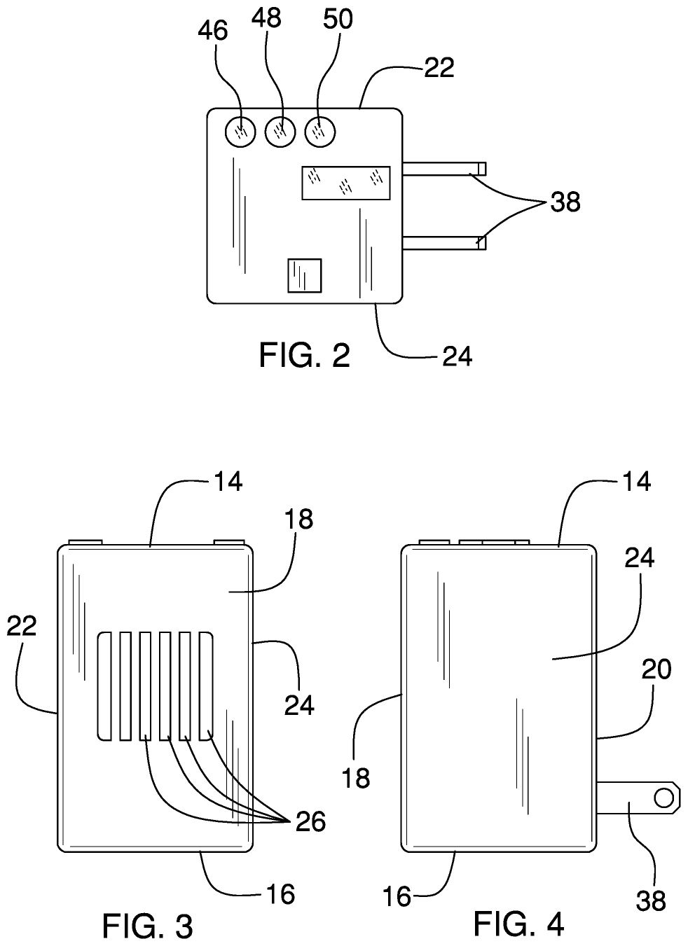

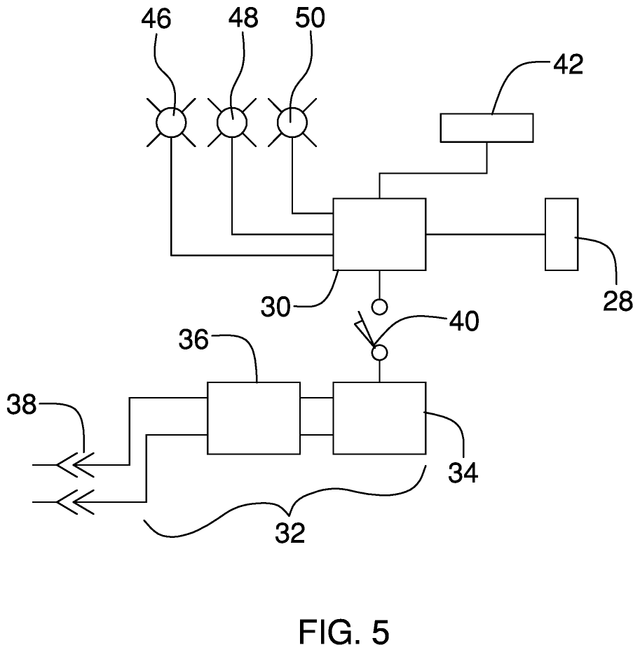

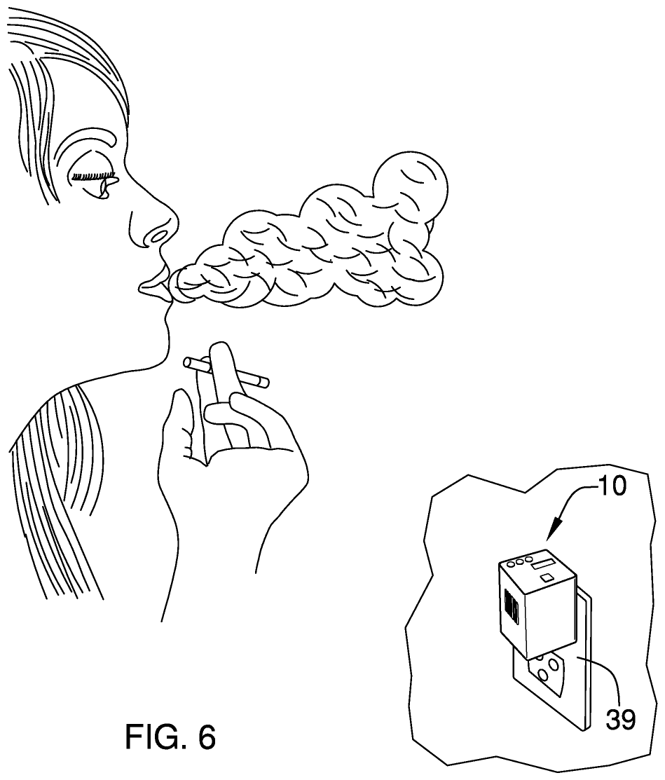

With reference now to the drawings, and in particular to FIGS. 1 through 6 thereof, a new smoke detector device embodying the principles and concepts of an embodiment of the disclosure and generally designated by the reference numeral 10 will be described.

As best illustrated in FIGS. 1 through 6, the smoke detector monitor apparatus 10 generally comprises a housing 12 having a housing top side 14, a housing bottom side 16, a housing front side 18, a housing back side 20, a housing left side 22, and a housing right side 24. The housing 12 may be rectangular prismatic with the housing top side 14 and the housing bottom side 16 being square. The housing 12 has a plurality of vent apertures 26 extending through the housing front side 18. The plurality of vent apertures 26 may be six parallel, rectangular vent apertures 26.

A smoke sensor 28 is coupled within the housing 12 adjacent the plurality of vent apertures 26. The smoke sensor 28 is configured to activate upon detection of smoke from cigarettes, cigars, and cannabis. A CPU 30 is coupled within the housing and is in operational communication with the smoke sensor 28.

A power source 32 is coupled within the housing 12 and is in operational communication with the CPU 30. The power source 32 may include a rechargeable battery 34, a battery charger 36 in operational communication with the battery 34, and a plug 38 in operational communication with the battery charger 36. The plug 38 extends from the housing back side 20 to engage a standard wall outlet 39.

A power switch 40 is coupled to the housing 12. The power switch 40 may be coupled to the housing top side 14 and is in operational communication with the CPU 30. A time indicator 42 is coupled to the housing 12. The time indicator 42 may be coupled to the housing top side 14 and is in operational communication with the CPU 30. The time indicator 42 displays the date and time of the last activation of the smoke sensor 28.

A plurality of status indicator lights 44 is coupled to the housing 12. The status indicator lights 44 may be coupled to the housing top side 14 and are in operational communication with the CPU 30. The plurality of status indicator lights 44 may comprise a red indicator light 46, a yellow indicator light 48, and a green indicator light 50. The red indicator light 46 illuminates when no smoke is detected, the yellow indicator light 48 illuminates when light to moderate smoke is detected, and the green indicator light 50 illuminates when significant smoke is detected. These smoke thresholds are predetermined within the CPU 30 based on the percentage concentration or parts per million of smoke particles detected by the smoke sensor 28.

In use, the plug 38 is engaged with the wall outlet 39 and the power switch 40 is activated. When a user sees the yellow indicator light 48 or the green indicator light 50 is illuminated, he or she may then check the time indicator 42 to attempt to determine who was smoking in the vicinity of the apparatus 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smoke detector monitor apparatus comprising:
a housing having a housing top side, a housing bottom side, a housing front side, a housing back side, a housing left side, and a housing right side, the housing having a plurality of vent apertures extending therethrough, the housing being rectangular prismatic and the plurality of vent apertures extending through the housing front side, the housing being elongated between the housing top side and the housing bottom side, the housing having a square cross-sectional shape perpendicular to the housing top side and the housing bottom side, the housing front side having a width configured to be less than a width of an outlet plate for a pair of vertically oriented outlets;
a smoke sensor coupled within the housing, the smoke sensor being coupled adjacent the plurality of vent apertures, the smoke sensor being configured to activate upon detection of smoke from cigarettes, cigars, and cannabis;
a CPU coupled within the housing, the CPU being in operational communication with the smoke sensor;
a power source coupled within the housing, the power source being in operational communication with the CPU, the power source including a rechargeable battery, a battery charger in operational communication with the battery, and a plug in operational communication with the battery charger, the plug comprising a pair of prongs extending from the housing back side wherein the plug is configured for inserting the pair of prongs into an electrical outlet;
a power switch coupled to the housing, the power switch being in operational communication with the CPU;
a time indicator coupled to the housing, the time indicator being in operational communication with the CPU; and
a plurality of status indicator lights coupled to the housing, the status indicator lights being in operational communication with the CPU.

2. (canceled)

3. The smoke detector monitor apparatus of claim 1 further comprising the time indicator displaying the date and time of the last activation of the smoke sensor.

4. The smoke detector monitor apparatus of claim 1 further comprising the time indicator being coupled to the housing top side.

5. The smoke detector monitor apparatus of claim 1 further comprising the plurality of status indicator lights being coupled to the housing top side.

6. The smoke detector monitor apparatus of claim 5 further comprising the plurality of status indicator lights comprising a red indicator light, a yellow indicator light, and a green indicator light, the red indicator light illuminating when no smoke is detected, the yellow indicator light illuminating when light to moderate smoke is detected, and the green indicator light illuminating when significant smoke is detected.

7. (canceled)

8. A smoke detector monitor apparatus comprising:
a housing having a housing top side, a housing bottom side, a housing front side, a housing back side, a housing left side, and a housing right side, the housing being rectangular prismatic, the housing having a plurality of vent apertures extending through the housing front side, the housing being elongated between the housing top side and the housing bottom side, the housing having a square cross-sectional shape perpendicular to the housing top side and the housing bottom side, the housing front side having a width configured to be less than a width of an outlet plate for a pair of vertically oriented outlets;
a smoke sensor coupled within the housing, the smoke sensor being coupled adjacent the plurality of vent apertures, the smoke sensor being configured to activate upon detection of smoke from cigarettes, cigars, and cannabis;
a CPU coupled within the housing, the CPU being in operational communication with the smoke sensor;
a power source coupled within the housing, the power source being in operational communication with the CPU, the power source including a rechargeable battery, a battery charger in operational communication with the battery, and a plug in operational communication with the battery charger, the plug extending from the housing back side, the plug comprising a pair of prongs extending from the housing back side wherein the plug is configured for inserting the pair of prongs into an electrical outlet;
a power switch coupled to the housing, the power switch being coupled to the housing top side and being in operational communication with the CPU;
a time indicator coupled to the housing, the time indicator being coupled to the housing top side and being in operational communication with the CPU, the time indicator displaying the date and time of the last activation of the smoke sensor; and
a plurality of status indicator lights coupled to the housing, the status indicator lights being coupled to the housing top side and being in operational communication with the CPU, the plurality of status indicator lights comprising a red indicator light, a yellow indicator light, and a green indicator light, the red indicator light illuminating when no smoke is detected, the yellow indicator light illuminating when light to moderate smoke is detected, and the green indicator light illuminating when significant smoke is detected.
